(19) United States
(12) Patent Application Publication
(10) Pub. No.: US 2006/0044806 A1
(43) Pub. Date: Mar. 2, 2006

(54) Light emitting diode system packages

(76) Inventors: Vladimir Semenovich Abramov, Moscow (RU); Alexander Eduardovich Puysha, Saint-Petersburg (RU); Alexander Valerievich Shishov, Moscow (RU); Nikolay Valantinovich Scherbakov, Moscow (RU); Inesse Petrovna Poliakova, Saint-Petersburg (RU)

Correspondence Address: Joseph Page, PO Box 757, La Jolla, CA, 92038, US

(21) Appl. No.: 10/925,477

(22) Filed: Aug. 25, 2004

(51) Int. Cl. F21V 5/04

(52) U.S. Cl. 362/337; 362/331; 362/332; 362/335; 362/336

(57) ABSTRACT

Light emitting diode systems disclosed include semiconductor diodes arranged in cooperation with electrical contacts, mounting provisions, and optical couplings; where the optical couplings include at least a Fresnel lens. A Fresnel lens is further coupled to additional optical elements such as a concave or ‘negative’ lens and still further to a reflector operating via principles of total internal reflection. Both the concave lens and the reflector are aspherical in preferred versions. A cover element of single piece plastic may be formed in a molding process whereby all three of these optical elements, i.e. the Fresnel lens, the negative lens and the reflector, are formed into the single plastic piece. Further, the plastic piece may be arranged to also accommodate auxiliary systems such as alignment indexing and fastening means as well as interlocking peripheral configurations.

### BACKGROUND OF THE INVENTIONS

1. Field

The following invention disclosure is generally concerned with light emitting diodes and more specifically, mounting and packaging for light emitting diodes.

2. Prior Art

Light Emitting Diode, LED, packaging arts is extensive well populated with various useful configurations. Indeed, each manufacture of specialty LED systems tends to re-design the package to accommodate the special features most interesting to a particular application at hand.

Recognized by some as industry leaders, 'Lumileds Lighting U.S. LLC. of California, make specialty packages to accommodate high performance features such as high brightness, specialty electrical contacts, color control, et cetera. Some of Lumileds LED system packages include unique lens or ‘cover’ elements. One of Lumileds' cover elements supports high brightness functionality. In another version, the cover element provides side extending electrical contacts for surface mounting assemblies. All manufactures of LED systems apply variations in packaging configurations to support particular functionality.

More particularly, and with reference to the art, one will note special configurations where LED semiconductors are combined with optical packages including Fresnel type lenses. U.S. Pat. No. 5,528,057 presents a first interesting instance of such combination. An exit window includes a lens to condense light from a source buried within the structure.

Inventors Hatakoshi et al teach in their U.S. Pat. No. 6,611,003 a special Fresnel zone plate device to concentrate and focus light produced at a semiconductor to a tiny spot. Thus, semiconductor output beams are manipulated with these special lenses to achieve preferred outputs.

An optics package to form highly collimated light includes a primary lens, a reflector, and a final output lens working in conjunction with each other to produce a highly controlled output beam. This invention is presented as U.S. Pat. No. 6,547,423 by Marshall et al.

Krames et al recognize the advantage of collecting side emitted light in their invention of U.S. Pat. No. 6,570,190. Angled sides increase side light extraction and couple that light into an output beam.

Canadian Martineau presents an LED using a single optical element with Fresnel optics on the inside surface of an output lens in U.S. Pat. No. 6,616,299.

Sasajima et al teach of highly collimated output beams from multiple point sources; these systems include use of Fresnel type optical elements. In U.S. Pat. No. 5,241,457, a rear window stop lamp for motor vehicles is described. These devices include an LED which emits light into a reflector element. Further, the light is thereafter reflected into a Fresnel type lens before propagating into an output beam.

While the field is widespread and busy, the present inventions have been devised and stand in contrast to those offered heretofore by others. While systems and inventions of the art are designed to achieve particular goals and objectives, some of those being no less than remarkable, these inventions have limitations which prevent their use in new ways now possible. Inventions of the art are not used and cannot be used to realize the advantages and objectives of these inventions taught herefollowing.

### SUMMARY OF THESE INVENTIONS

Comes now, Abramov, V. S.; Puysha, A. E.; Shishov, A. V.; Scherbakov, N. V.; and Poliakova, I. P. with inventions of LED system packages including devices and articles. These systems include highly specialized cover elements having compound optical systems with exceptionally high light collection efficiency. Each element of the multi-element optical arrangement is specified and arranged with particular attention to the nature of light emission from a semiconductor die like those used in light emitting diode configurations. In addition to these highly unique cover elements, these inventions may further include additional subsystems such as chromacity shifting media, precision indexing and alignment schemes, high performance substrate mountings, and electrical lead traces.

A first noticeably unique feature includes a complex Fresnel lens. A single Fresnel lens is arranged about two geometric bodies, a plane and a conic section. These arrangements promote most efficient coupling of light from the cover into a particularly specified beam such as a low divergence beam. In addition, special asymmetric Fresnel lenses are contemplated for beam shaping functionality.

Another important feature of these optical source packages includes aspheric concave lenses and reflectors. Operated with the object distance less than the focal length; a semiconductor emitter lies close to the lens surface on its axis, the lens axis being colinear with the Fresnel lens symmetry axis. In these special arrangements, a reflector is typically coupled to the side emitted light while the lens is strongly coupled to the normally emitted light.

Some versions include high precision indexing means which serve both alignment and mechanical coupling functionality. The cover additionally incorporates a special periphery for placing a plurality of similar devices efficiently next to one another which promotes highest density beams.

### OBJECTIVES OF THESE INVENTIONS

It is a primary object of these inventions to provide new and useful packaging for light emitting diode systems.

It is an object of these inventions to provide packaging for light emitting diode systems to produce a preferred optical output.

It is a further object to provide packaging for light emitting diode systems where said packaging promotes highly collimated optical beams as output.

A better understanding can be had with reference to detailed description of preferred embodiments and with reference to appended drawings. Embodiments presented are particular ways to realize these inventions and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 is a cross sectional diagram of package in relation to a ‘mounted’ diode semiconductor in agreement with principles of these inventions;

FIG. 2 is a cross sectional diagram showing a light emitting semiconductor die and its unique emission pattern;

FIG. 3 is cross sectional view of a cover element;

FIG. 4 illustrates some special mathematical relationships and geometries with respect to lens and reflector systems of these inventions;

FIG. 5 a top view diagram illustrating a special surface relief pattern;

FIG. 6 is a top view of a version having asymmetric surface relief patterns for specialized applications demanding asymmetric output beams;

FIG. 7 illustrates the narrow beam output of a single LED device of these inventions;

FIG. 8 shows a pattern formed by an arrangement of a plurality of repeat units;

FIG. 9 illustrates the narrow beam pattern formed from a plurality of repeat units;

FIG. 10 further details a tiling scheme which may be used to pave large areas of arbitrary shape;

FIG. 11 is a side-view cross section of three repeat units mounted on a single substrate;

FIG. 12 shows a multi-element compound system; and

FIG. 13 is a diagram which shows a group cover element and its coupling system in cross section.

### PREFERRED EMBODIMENTS OF THESE INVENTIONS

In accordance with each of preferred embodiments of these inventions, there is provided LED system packages. It will be appreciated that each of these embodiments described include both an apparatus and that the apparatus of one preferred embodiment may be different than the apparatus of another embodiment.

Generally when one refers to an ‘LED’ it is meant that electronic support, mounting systems and mechanical support, the lens or lenses and other assorted packaging features, are included along with the actual semiconductor—the ‘diode’ in the acronym. This is because these systems are tightly integrated and sometimes are formed integrally by a manufacturer. When LED units are commercially produced and sold, they are generally sold as a complete system including these necessary subsystems. While one might purchase bare die, reference to an ‘LED’ is directed to far more that the diode.

Standard LED packages of the art are typically build about a lead frame. A reflecting receiving cup or cavity is formed at the end of an electrical contact. A semiconductor die is affixed at the bottom of the reflector via glue or soldering. A wire bond connects a second pole to a second electrical lead; part of the lead frame. This assembly is put into a mold where a liquefied polymer resin is injected and envelopes the diode and contacts, and forms a lens thereabout. The lens and reflector operate to form a more concentrated output beam. In commonly available LED systems, it is possible to couple a majority of the output optical energy into a beam having a divergence of no less than about 30 degrees.

However in some applications, for example signaling systems used in railroads, it is desirable and even necessary to couple the optical output from the diode into a much tighter or ‘narrow’ output beam. Indeed, specialty applications may call for an output beam having just a few degrees of divergence. It is possible to create a narrow beam by placing a light emitting diode at the focus of a simple lens, however this solution requires an end user to add expensive optics to the LED packaged source and is accompanied by additional problems, such as alignment difficulties. It is preferred that LED packages be custom made to promote a narrow beam output. To answer this call, highly specialized and unique LED systems and packages are presented.

While LEDs having narrow beam outputs are in very high demand, other pre-specified beams and beam shapes are also necessary in some application specific projects. For example, asymmetric beam patterns may be required where illumination fields are not circular. Very high aspect ratio ‘ribbon’ beams may be useful in some systems while multiple spot arrays are useful in others. For these reasons, it is quite desirable to incorporate high efficiency optical systems directly within LED packages. This permits a user the luxury of not having to form an expensive complex optical system exterior to the LED.

Packages presented here are characterized as having exceptionally high optical collection efficiency. Further, they operate to couple optical energy into a highly collimated beam having low divergence or specialized particular divergence properties. These systems may also be arranged whereby they are highly cooperative in groups of similar devices to form a specialized light output. Further, the systems described are arranged in special configurations suitable for mass production.

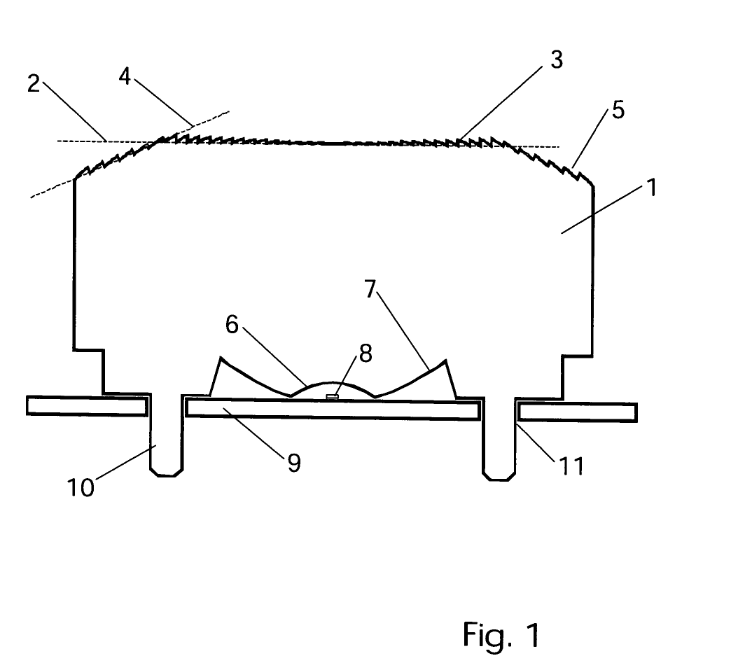

With reference to FIG. 1 where a first preferred embodiment is set forth in a cross sectional diagram, a single piece, molded plastic cover 1 has formed therein at least five major components including: an output lens, a primary lens, a reflector, indexing and mechanical coupling means, and a non-circularly shaped periphery. The example illustrated in the drawing includes a substantially planar region 2 defining a top surface of the cover into which is formed a special surface relief pattern sometimes and herein known as a Fresnel lens 3. A curved surface is divided into a plurality of annular regions as is well known in the optical sciences for making a lens onto a substantially planar surface. In another surface, a surface which occupies a conic section 4, a continuation of the Fresnel ridges 5 or surface relief pattern, is formed. A primary lens 6 which is preferably a refractive lens of aspherical shape is provided to receive light propagating from a semiconductor source and couple that light into the material from which the cover element is formed. A reflecting optical element 7 with lensing power is formed onto a surface of the cover element as shown. Light incident upon the reflector is redirected in a upward direction towards the Fresnel surfaces; i.e. the top surfaces of the cover element. These three optical elements operate together to form a powerful and highly efficient optical collection apparatus tuned specifically to the emission patterns of semiconductor die. The semiconductor die 8 is mounted and mechanically coupled to a substrate 9 which in some versions is a simple printed circuit or ‘PC’ board having electrical traces built into its surfaces. Pins 10 formed integrally with the cover element are arranged to fit with complementary and precisely located receiving holes in the PC board to form a secure and well aligned mechanical interlock between the cover and PC board and thus implicitly with the semiconductor chip.

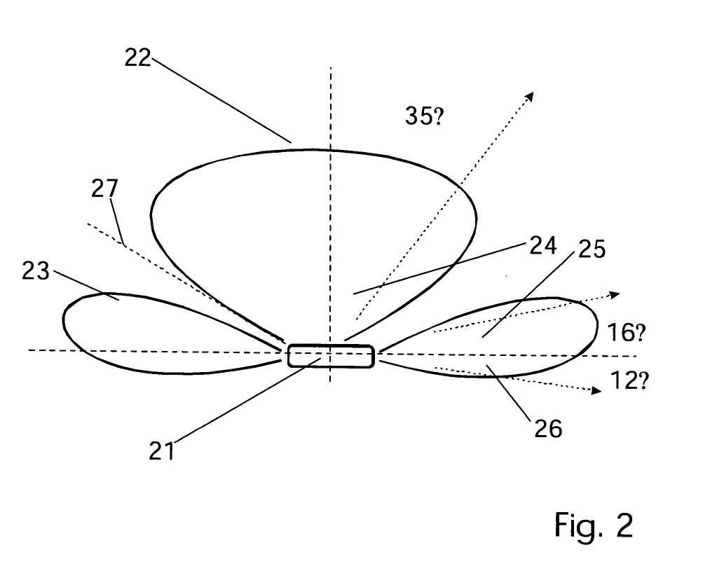

As it is a fundamental objective of these devices to couple light generated in a slab of semiconductor material into a highly controlled and well defined beam, it is useful to review the nature and profile of optical output which emanates from the chip. FIG. 2 illustrates one semiconductor and its optical output with particular regard to spatial distribution. A semiconductor die 21 is typically a rectilinear crystal having a plurality (generally 6) of planar surfaces. From these surfaces, light generated in the crystal exits the semiconductor which is under proper electrical drive conditions. The light does not emanate from a single point in a spherical wave as ideal worlds might have, but rather the light emanates with various intensity in directions more or less perpendicular to a crystal surface with the higher intensities being in directions more perpendicular. In some semiconductor chips, a primary beam 22 is emitted from a large top surface. The beam is brightest on the vertical axis and has reduced intensities as the angle from the vertical is increased. An arbitrary measure such as ‘half-width-at-half-max’ HWHM may be used to specify the beams extrema, indicated by dotted line and angle 24, or maxima divergence as 35 degrees. The sides of the semiconductor also emit light in asymmetrical side beams 23. The upper half of the beam tends to be brighter than the lower half and may be described by a higher divergence angle. The top half of the side beam may subtend an angle 25 of about 16 degrees, and the lower half of the side beam may subtend an angle 26 of about 12 degrees. Careful review will suggest that in a certain direction, indicated by dotted line 27, perhaps no light at all will be emitted as it is prevented from escaping the semiconductor chip geometry by mechanisms such as total internal reflection.

Cover Elements

One will appreciate great advantages offered by modern polymer materials sciences. Cover elements of these inventions are meant to form part of an optical path and are necessarily transparent and of complex shape. Polymer materials can be prepared such that their final form is very clear with only slight defects and occlusions and accordingly make great optical components. Further, polymers support advanced molding processes which permit very complex integrated shapes. In the particular instance, a single piece polymer ‘cover element’ may actually be comprised of more than seven individual components. While common polymer lenses known in conventional LEDs usually have only a front spherical surface, i.e. the system is operated in an immersion lens configuration; in contrast, these inventions include a cover element which requires detailed complex integration of many cooperating components. Thus, polymer materials serve particularly well the present inventions in a manner not found previously in uses of polymers to form optical elements.

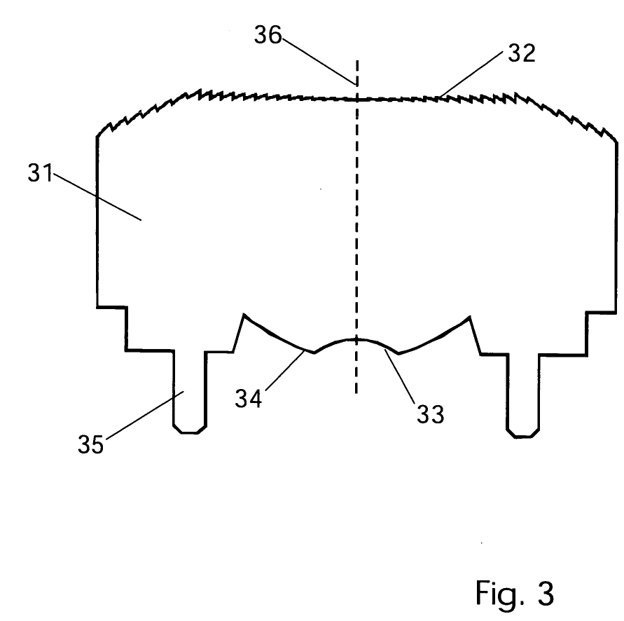

A preferred version of a cover element 31 of these inventions is shown in FIG. 3 in isolation away from any substrate and semiconductor. The major components molded integrally as a single piece include at least: primary lens 33, reflector 34, periphery, output lens 32, and mechanical couplings 35.

Primary Lens

The primary lens 33 receives light emitted from several surfaces of the semiconductor and couples that light from a low index of refraction free space (or other medium) into the high index of refraction plastic medium of the cover. The high/low index interface in combination with the curved shape surface forms the refraction lens. In best versions, the semiconductor chip is located quite near the surface of the lens and in any case closer than the focal point of the lens. Thus in this configuration, the lens is said to be a ‘negative’ lens. While it is possible to deploy convex lens configurations as a primary lens in these inventions, it has been determined that the concave configurations as shown better couple light in a preferred way.

While some special case versions might include spherically shaped surfaces, preferred versions include a lens having an aspheric surface shape. Since this lens is formed in a molding process and is not ground as glass lenses are, it is relatively easy to enjoy the benefits aspheric optics offers. A mold tool is prepared with an aspheric shape and that shape is thereafter repeatedly passed to cover elements formed in the tool.

By careful calculation and tedious experimentation, it has been determined that optical beams emitted from semiconductors as shown may be best collected and refracted at lenses having aspheric surfaces described by the equation: x²+y²−Az−Bz²=0. Still further, the constants of proportionality when defined as A=6.587 and B=0.537, provide a preferred collection characteristic.

The primary lens is axially symmetric and concentric with a system axis 36.

Reflector

Reflectors 34 of these systems are special. These reflectors are preferably aspheric and take the shape described by the polynomial: x²+y²+Cz+Dz²=0. When C=−5.936 and D=−0.85, and these reflectors are used with semiconductors of predetermined form, the reflector performs a beam redirection which tends to most effectively further couple side beams into the system output. (Of course, the special case where C=0 renders the reflector spheric and is considered an exceptional included case)

While preferred versions of these reflectors are embodied as total internal reflection TIR mirrors, that is, a mirror formed at a high/low index of refraction junction and high angles of incidence, these are not the only configurations possible. Where TIR mirrors are not practical, it is possible to polish the surface and apply a metallic coating to form a reflective mirror. In either case, the means of reflection is less important than the shape of the reflecting surface which may in either case be formed in a molding process.

The reflector is also axially symmetric, and concentric with the primary lens. Further, its inside peripheral limit may correspond with the primarily lens outside periphery at a single circle.

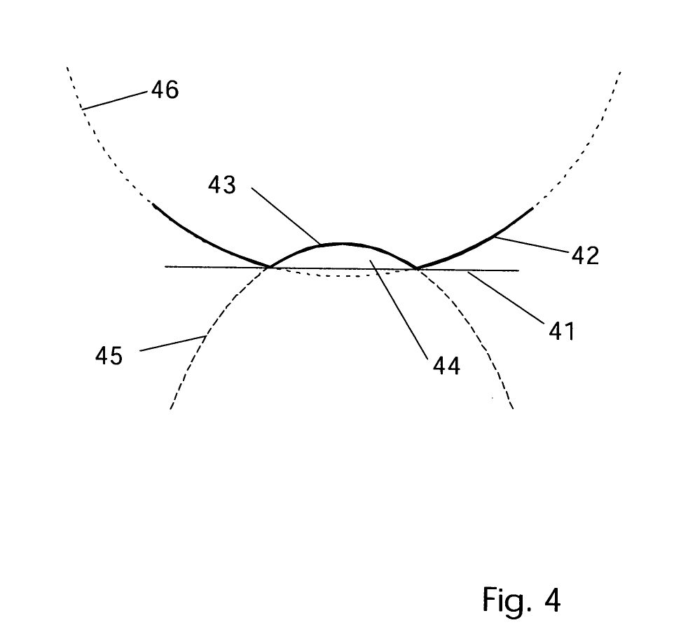

One can more fully appreciate the relationship between the primary lens and reflector in preferred arrangements in view of FIG. 4 which shows two related parabolas. Plane 41 corresponds to a plane in which the bottom of the semiconductor is affixed and bonded. The solid curve 42 is the aspheric reflector which lies in a first parabola, the solid curve 43 is the aspheric lens which lies in a second parabolic curve. The space 44 accommodates a light emitting semiconductor therein. Dotted lines 45 and 46 illustrate the mathematical constructs which describe the preferred aspherics.

Output Lens

An output lens finally couples refracted and reflected beams into a final condensed output beam and transmits light propagating in the cover element into free space. Output lenses of these devices are disposed upon the top surfaces of these cover elements. By ‘top surfaces’ it is explicitly pointed out that the top of a cover element is comprised of at least two surface portions. Best arrangements include a first surface portion of circular area in a planar section and a second surface portion of annular area in a conic section. These two geometric bodies are made concentric and the outside diameter of the circle is identical to the inside diameter of the annulus. In this way, a very special geometric advantage is found to support a high performance lens with particular nature for coupling output of a semiconductor into a prescribed beam of precise dimension.

In best versions, surface relief patterns are molded into the top surfaces during manufacture. Since molding supports complex shapes, preferred arrangements include high efficiency Fresnel type lenses. Into a plurality of annular regions, a lens portion, i.e. a curved surface, is formed. The curved surface of each region cooperates with the curved surface of the other regions in that the nature of the curve for all regions is set by a mathematical relationship having radial dependence.

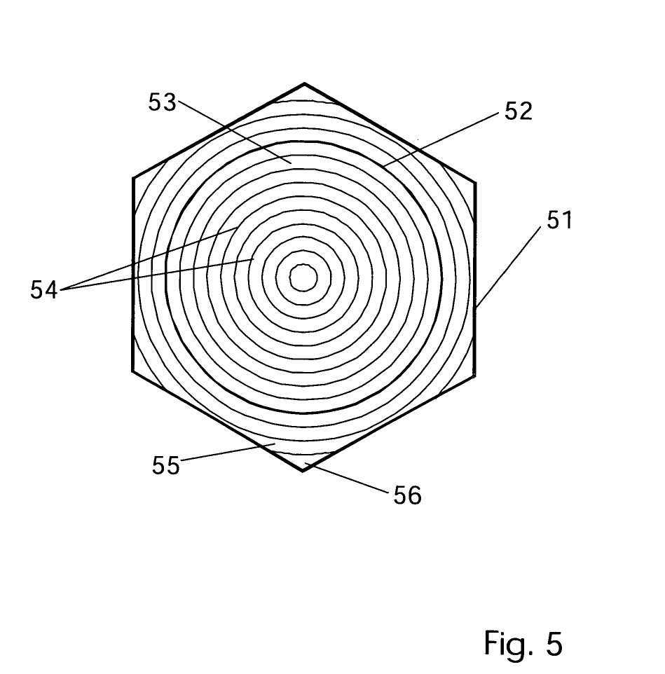

In FIG. 5, the top surfaces of a cover element are illustrated from a top down view. Most importantly, a six sided polygon or hexagon 51 forms the peripheral limits of the favored shapes for these devices. A circular demarcation 52 divides the first top surface portion from the second top surface portion. Ridges 53 in the first top surface portion form complete concentric circles. The second top surface portion, that is the surface portion which lies substantially in a conic section area, includes similar circular ridges. However, to fit the maximal number of ridges for best efficiency, some of those ridges are broken about the circle in which they lie. The annulus marked as 55 is partly cut off by the peripheral edge of the cover element. Similarly, most portions of annulus marked as 56 are cut off by the device periphery. Despite these interruptions, the annular regions remain in agreement with the mathematical definition for the Fresnel lens and their surfaces are shaped accordingly. In this way, they contribute to the total light output and promote a most efficient narrow beam.

Aspheric Fresnel

While some preferred Fresnel lenses have simple r² radial lens relationships, that is the relationships of spherical optics, it is also possible to form Fresnel lenses with aspherically defined surface shapes. The dependence may be different than simple r² and may include a second term dependant upon the first order radius. Thus the Fresnel lens is also allowed to a be of non-spherical nature. A highly novel aspect to this approach includes tuning the curved surfaces in agreement with the non-spherical wavefront incident upon the lens. More particularly, tuning the curves of the Fresnel annuli to cooperate with the particular spatial optical output pattern natural to a light emitting semiconductor die which is necessarily a multi-faceted object typically a cube or cylinder having rectangular cross section.

Elliptical Fresnel

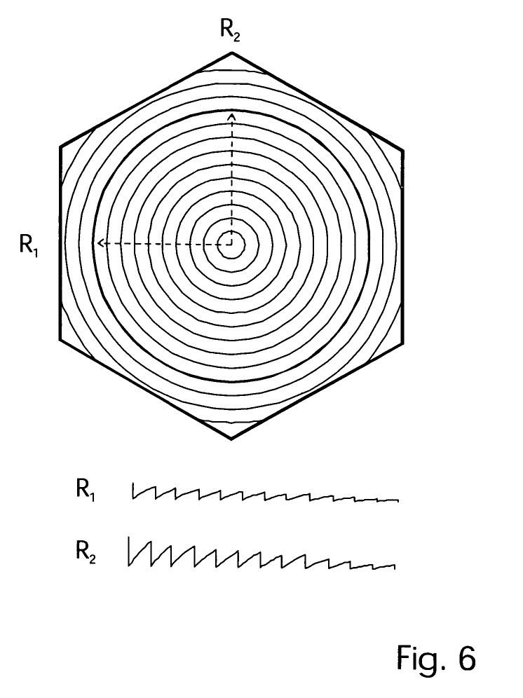

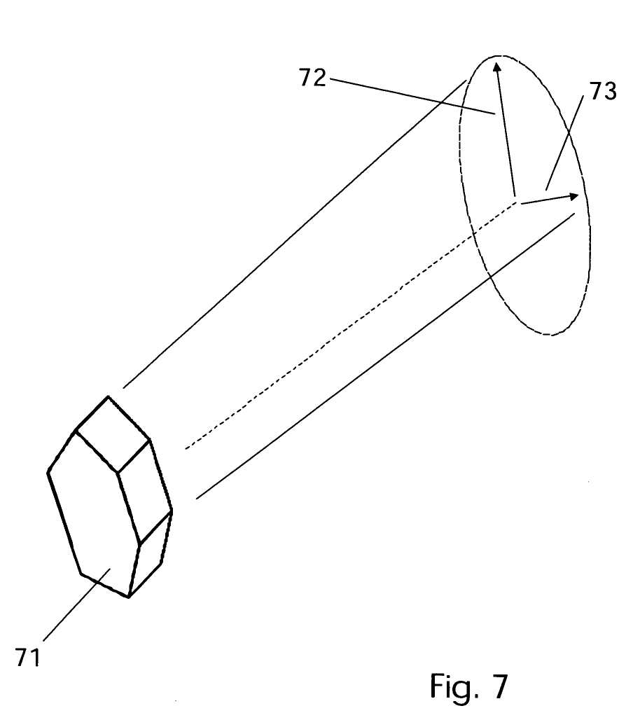

Further, the lens definition for the Fresnel lens is not required to be symmetric in the two transverse directions. The lens may have one curvature in a first direction and a different curvature in an orthogonal direction. FIG. 6 shows the top of a cover element of these inventions including a Fresnel lens on its top surfaces. Further, the figure illustrates two orthogonal directions R₁ and R₂ indicated by the dashed lines. Below, are surface topology maps showing the curvature along direction R₁ is different than the direction corresponding to R₂. This has the effect of creating an output beam having a higher divergence in one direction than the other. Thus, an elliptical beam will be formed as output. In this way, it is possible to realized beams specified with different divergence in orthogonal directions; for example a beam of 5° by 10° is created in this way. FIG. 7 illustrates how a single element LED with appropriately designed cover element 71 forms an asymmetric output beam having a major axis 72 greater in extent than the minor axis 73.

Diffractive Alternatives

Fresnel lenses offer considerable advantage in their ease of manufacture and high efficiency, alternatives output lenses may be used in some special versions of these inventions. Diffractive optics sometimes make excellent high performance beam shaping elements. Particularly when the output beam is of unusual or complex shape; for example ribbon beams, multiple spot arrays, et cetera. Further, diffractive optics such as gratings and kinoform can be formed in molding processes. Other diffractive optics, for example holographic optical elements, can be formed in other processes and applied later to molded covers of these inventions.

Periodic gratings formed into the top surfaces of the cover member of an LED device may be used to efficiently direct the collected light into a beam of prescribed definition. For example, a beam characterized by a spot array in the far field may be achieved via an appropriate grating. Gratings may also be used with simple outputs. A collimated beam may be supported by a grating having circular symmetry with increasing period as a function of distance from the system center i.e. in the radial direction.

Holograms are sometimes diffractive elements which may be formed in a medium with spatially varying index of refraction in a complex ‘fringe’ pattern. These devices may be formed on a thin film and bonded to the surface of a cover element in a two step process to form a highly specialized output lens. Holograms could couple light to any of a great variety of output beams of complex nature.

Finally, kinoform micro structures formed onto the top surface of a cover may operate as an output lens in some versions of these inventions.

Hex Peripheries in Plurality Systems

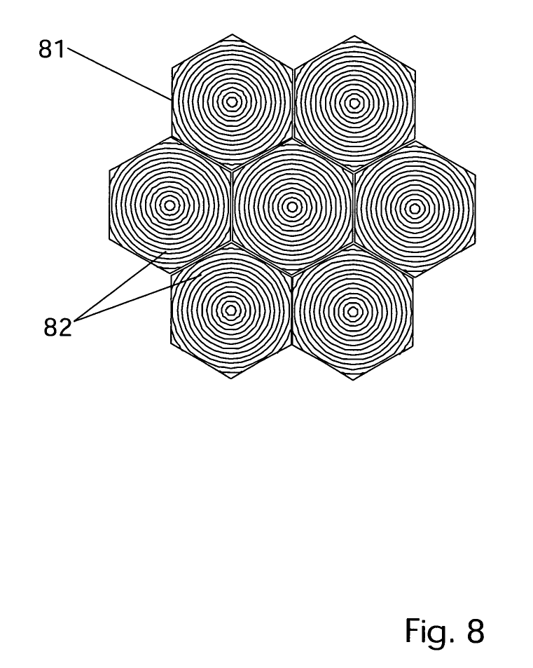

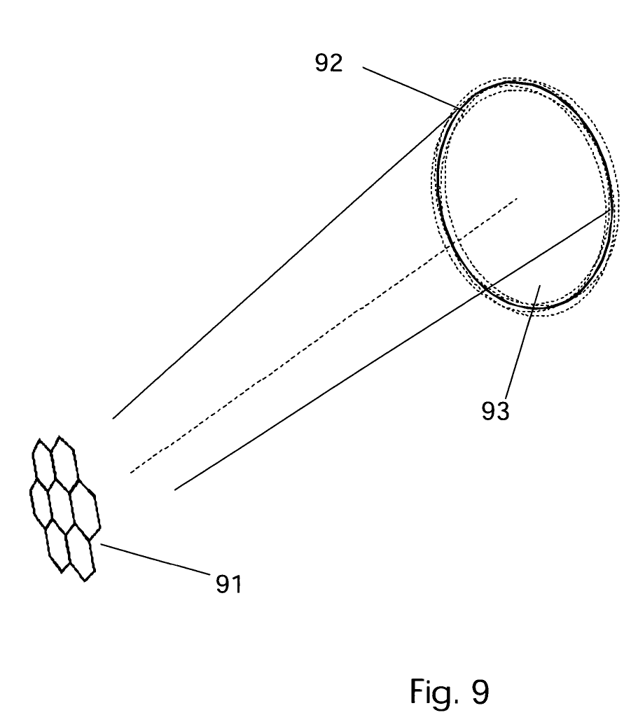

In some applications, it is desirable to maximize the amount of output light per unit area in an output beam produced by these inventions. To advance this objective, covers are formed with a view to arrangements of tightly packed units having minimal losses there between; i.e. minimal ‘dead space’. Unit devices can be formed with hexagonal peripheries which negligibly upset coupling of light from diode semiconductors into cylindrical output beams, but permit side-by-side arrangements of a plurality of unitary devices. FIG. 8 illustrates how cover elements having hexagon 81 shaped peripheries can be tightly packed 82 in a small area. Despite the hexagonal shape at the device periphery, the beam shape remains circular and is independent of the shape of the cover element except in the very near field. Arrangements such as that shown in FIGS. 8 and 9, have in the far field seven overlapping beams which form a nearly uniform illumination field. FIG. 9 illustrates this overlap as device ensemble 91 form beam of circular cross section 92. The illumination field 93 is of good uniformity due to the integral effect of the plurality of units.

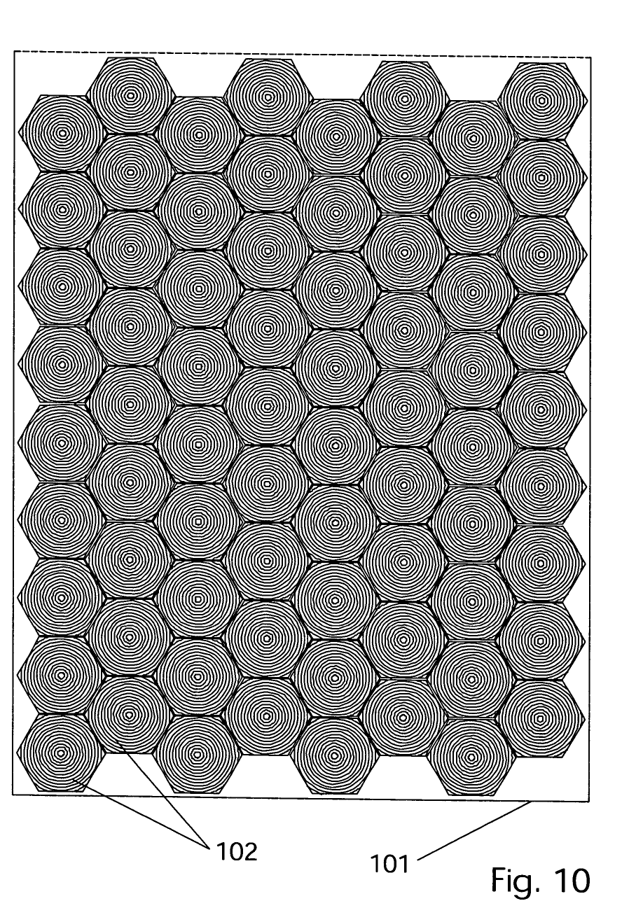

Of course, this paradigm can be extended to large areas where a great plurality of units pave the entire area. FIG. 10 shows how a substantially rectangular surface 101 is covered with a plurality of units 102. The output beam of this device could remain with very low divergence; in some cases less than 3 degrees.

Indexing and Alignment Means

Since these LED packages include high performance optical elements, i.e. lenses and mirrors, it is part of the entire package that precise alignment mechanisms be provided. Cover elements of these inventions are distinct with respect to common cover elements of most LEDs. Those cover elements are formed with the semiconductor and lead frame in place while the cover is molded. Cover elements taught herein are preferably molded and joined with the semiconductor and base substrate at a later time when the cover element is hard. As such, opportunity is presented for a highly precise alignment mechanism.

A base substrate includes receiving holes therein; said holes being well positioned and formed with precision. The bottom of a cover element cooperates with the substrate holes as it has thereon ‘pegs’ or ‘pins’. These pins are formed of the same material (i.e. plastic) as the cover element and they are formed integrally with the cover element. Where covers are made of polymers, these pins are ideal as they may be melted over after they are pushed through the holes of the substrate.

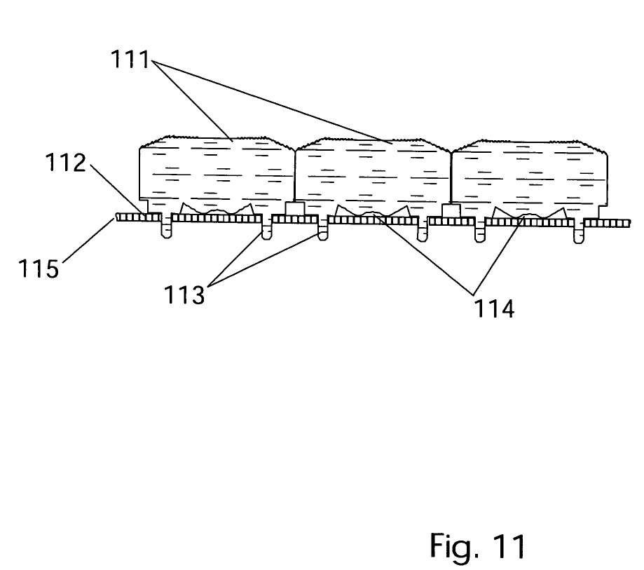

FIG. 11 shows three units side by each. Each unit 111 is placed onto the substrate 112 whereby at least two of its pins 113 are pushed through holes in the substrate. When the cover elements are fully seated in the substrate, a small space 114 is formed between the cover element and the substrate to accommodate a semiconductor die therein. The substrate of the figure is shown to receive three cover elements but is drawn with an undetermined length 115 which might be extended to great lengths to accommodate more units.

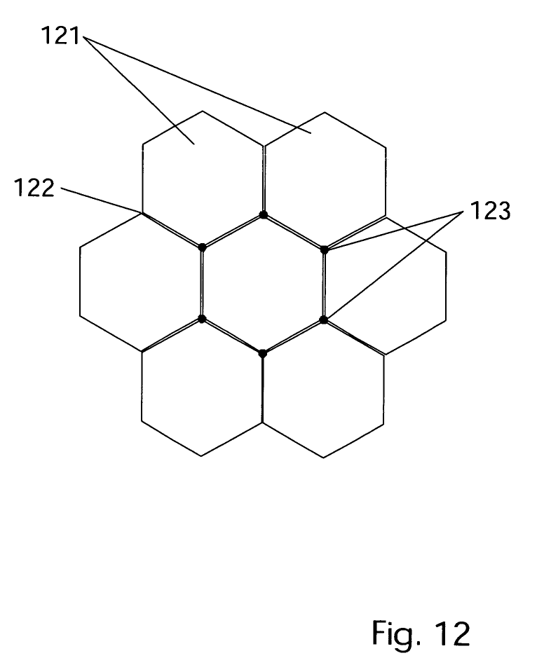

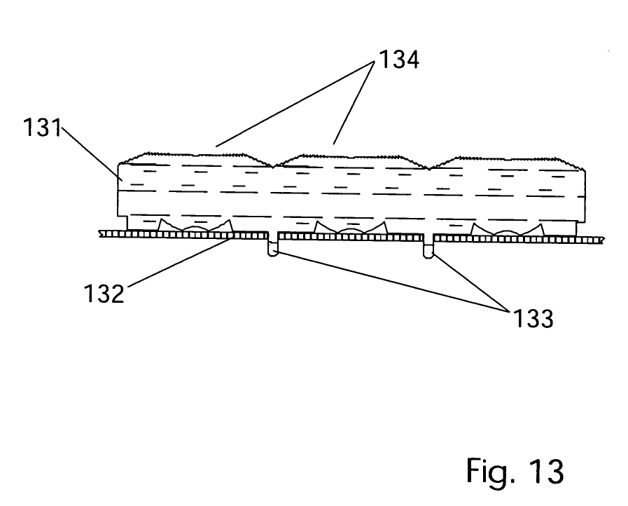

It is not necessary that each cover have its own set of pins. Indeed, it is not necessary that each cover element be formed individually and contrarily they may be formed as one compound system. FIG. 12 shows a seven unit cover element formed in a single mold. Each element 121 shares at least three sides 122 with other elements and the center element share all of its sides with other elements. Six pins 123 may be placed in corners as shown to provide mechanical alignment and coupling means for the compound cover element which may be brought to a specially prepared substrate with six similarly positioned holes. FIG. 13 shows how this compound cover element 131 appears in cross section in conjunction with a substrate 132. Pins 133 have been pushed through holes in the substrate so that alignment is assured between the lenses and the semiconductor emitters mounted on the substrate. In this way, each unit's top surface 132 operates independent of the others to couple light into a single beam of low divergence.

Base Substrate

The base substrate is primarily a mere flat surface. Best versions include alignment and affixing mechanisms in the form of holes well placed and precisely drilled through the flat surface clear through to the other side.

In some versions, a substrate is fashioned as a circuit board which includes printed electrical traces for electrical coupling. Further, the board may include mounting pads suitable for receiving thereon and bonding thereto a semiconductor die. These pads should be precisely located with respect to alignment holes in the substrate for lenses to operate to their full potential. Pads may be raised to permit an offset between the die and the surface of the substrate in designs of lenses which prefer such offset. If a semiconductor die is not well aligned with respect to the lens, light is not coupled properly into a desired output beam but rather distortion will greatly reduce the system efficiency. In best versions, these substrates support wave soldering manufacture processes. Indeed, A PC board may be processed with many electrical components, wave soldering, and other associated manufacturing steps, and thereafter joined with cover elements to form highly integral LEDs directly on PC boards.

One will now fully appreciate how high performance LED packages may be arranged with compound Fresnel type lenses in conjunction with aspheric optical elements. In particular, LED packages for producing highly collimated narrow beam optical outputs or another well defined beam shape of specific nature. Although the present inventions have been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto

What is claimed is:

1) Light emitting diode packages comprising a cover element of transparent material having a top surface into which a Fresnel type lens is formed in a surface relief pattern.

2) Light emitting diode packages of claim 1, said Fresnel lens is formed in two portions, a first portion lying in a circular area of a plane section, and a second portion lying in a conic section concentric with the first portion, the conic section has an axis normal to the plane of the first portion.

3) Light emitting diode packages of claim 2, said cover further comprising an under surface with a primary lens formed therein, said primary lens is a concave lens axially symmetric with said Fresnel lens.

4) Light emitting diode packages of claim 3, said primary lens is an aspheric lens.

5) Light emitting diode packages of claim 3, said under surface further comprises a reflector concentric with said primary lens.

6) Light emitting diode packages of claim 5, said reflector is a total internal reflection, TIR, type reflector.

7) Light emitting diode packages of claim 5, said reflector is an aspheric optical element.

8) Light emitting diode packages of claim 2, said cover element comprises an under surface which forms a concave primary lens and a reflector, axially arranged in cooperation with said Fresnel lens.

9) Light emitting diode packages of claim 8, said primary lens is defined by an equation of the form: x²+y²−Az−Bz², and said reflector is defined by an equation of the form: x²+y²+Cz+Dz².

10) Light emitting diode packages of claim 9, where A=6.587 and B=0.537; and further where C=−5.936 and D=−0.85.

11) Light emitting diode packages of claim 2, said Fresnel lens being characterized as having a different lensing power in orthonormal directions.

12) Light emitting diode packages of claim 8, said cover element further comprises indexing and alignment means well positioned with respect to a system origin and geometric axis.

13) Light emitting diode packages of claim 8, said cover elements having a periphery of hexagonal cross section in a plane normal to the symmetry axis.

14) Light emitting diode packages of claim 2, said cover element includes a top surface having a plurality of discrete Fresnel lenses, each Fresnel lens in a repeat unit of hexagonal cross section.

15) Light emitting diode packages of claim 14, said cover further comprising indexing and alignment means well positioned with respect to a system origin and geometric axis.

16) Optical sources comprising: a diode; a substrate; and a cover,
said diode is a semiconductor type light emitting diode affixed to said substrate,
said substrate provides mechanical and electrical coupling to said diode and mechanical coupling to said cover, and
said cover is affixed to said substrate via said mechanical coupling, said cover is an optically transparent material having a top surface operable as an optical lens.

17) Optical sources of claim 16, said top surface having a surface relief pattern thereon, the surface relief pattern forming a Fresnel type lens.

18) Optical sources of claim 17, said top surface is formed in two concentric sections a circular planar section and an annular conic section.

19) Optical sources of claim 18, said cover element further comprising an under surface having thereon a concave lens sharing an axis with said Fresnel lens.

20) Optical sources of claim 18, said cover element further comprising an under surface having thereon a concave lens and a reflector each concentric with the other.

21) Optical sources of claim 20, said reflector is TIR type reflector.

23) Optical sources of claim 21, said reflector is optically coupled to side facets of a light emitting semiconductor diode.

24) Optical sources of claim 20, either of said concave lens or reflector is an aspheric optical element.

26) Optical sources of claim 24, said lens surface is defined by the equation: x²+y²−6.587z−0.537z² and said reflectors surface is defined by the equation: x²+y²−5.936z−0.85z².
